(19) United States
(12) Patent Application Publication
(10) Pub. No.: US 2009/0152288 A1
(43) Pub. Date: Jun. 18, 2009

(54) Automatic product vending machine

(76) Inventors: Roberto Guglielmi, Schio (IT); Antonio Scapin, Torrebelvicino (IT)

Correspondence Address: BUCKNAM AND ARCHER, 1077 NORTHERN BOULEVARD, ROSLYN, NY, 11576, US

(21) Appl. No.: 11/989,065

(22) PCT Filed: Jul. 17, 2006
(86) PCT No.: PCT/EP2006/006998

§ 371 Date: Jan. 18, 2008

(30) Foreign Application Priority Data
Jul. 18, 2005 (IT) VI2005A000199

(51) Int. Cl. B65H 3/02; B65H 1/08; G07F 11/46

(52) U.S. Cl. 221/13; 221/259; 221/133

(57) ABSTRACT

An automatic product vending machine is provided where the user can withdraw the selected product directly from the machine, the storage area for the products is a rack and the dispensing device of the single product is a frame on which a pusher is mounted which causes the selected product to fall into a tray, which positions the product at an opening which permits its withdrawal by the user.

The present finding regards an automatic product vending machine, according to the general part of claim 1.

The automatic product vending machines are by now widespread in many places, from industrial to civilian settings, for example in structures such as train stations, hospitals, schools, and refreshment services of various type where the user can withdraw the desired product directly from the machine.

At the state of the art, there are automatic vending machines on the market which have different technologies, both from a structural and functional standpoint.

In particular, product vending machines are known which foresee a plurality of rotating platforms, subdivided into compartments which, by rotating around their own axis in an appropriate manner, are capable of positioning the preselected product at a small door, which upon opening the user may access the inside of the vending machine and then withdraw the desired product.

Other vending machines foresee the use of rotating spirals, with horizontal or vertical axis, which convey the product in correspondence with an opening which permits its withdrawal by the user.

Whatever the mechanism which moves the products from the storage area to an opening, to make their withdrawal by the user more accessible, the automatic vending machine is essentially composed of a cupboard metallic structure, which constitutes the cover of the machine, equipped with a door that can be opened and is adapted to permit access inside the same vending machine for loading the products to be dispensed and for carrying out maintenance operations.

The drawbacks of the automatic vending machines of known type are numerous, the main one being the considerable size of the containment structure of the vending machine itself, as a consequence of the complexity of the mechanisms necessary to realise the dispensing, as well as the fact that the products to be dispensed do not fully occupy the available space of the storage area.

Another drawback is the complexity of the loading operation of the products into the vending machine.

In fact, if one uses rotating platform vending machines, it is necessary that the operator, with the machine's access door open, precisely positions the products to be dispensed, correctly depositing them in the corresponding sector of the disk so that when the user opens the small withdrawal door, the product can be easily taken; that is, in the case of spiral devices, the operator must correctly insert the products in the gap between two successive spirals, so that when the spiral rotates the product located at the end of the spiral, it falls into the withdrawal zone.

Moreover, for lowering management costs and for making different types of products available for the user in a same machine, every automatic vending machine does not dispense one single product but is prearranged so to be able to dispense a plurality of products, with different qualitative as well as size and shape characteristics.

Such need therefore involves the necessity of having, in the single vending machine, a storage area of the products and a withdrawal device which are easily and rapidly modifiable, so to be adapted for optimal functioning with a wide range of products of different sizes, shapes and weight.

Such drawbacks and such needs cannot be respectively eliminated or satisfied with the vending machines of known type, due to their structural form and/or functioning which is hard to modify if not with operations which require variations of the entire dispensing system, with consequent loss of time along with the need to employ qualified personnel, all to the detriment of the machine productivity.

Object of the present invention is that of making an automatic vending machine which lacks the drawbacks manifested by the similar products of known type.

Further object of the finding is that of making an automatic vending machine with simple construction, minimal maintenance, easy access and rapid product loading.

Further object of the finding is that of making an automatic vending machine where the products to be dispensed are totally visible to the user.

Further object of the finding is that of making an automatic vending machine wherein the loading operations of the products in the storage area and the programming of the machine functioning do not require the use of qualified personnel.

Such objects are obtained with the making of an automatic vending machine which differs from similar apparatuses for the particular conformation of the storage area and the product dispensing device.

Structurally, the automatic vending machine according to the invention is characterised in that the storage area of the products is composed of a simple rack in which both the shelves and the dividing walls which divide the containment cells of the products on each shelf are movable, so that from the combination of the horizontal arrangement of the shelves with the vertical arrangement of the walls, it is possible to obtain on each shelf any cell size so to be able to receive products of any shape or size.

Still structurally, the vending machine according to the finding is further characterised in that the dispensing device of the single product is composed of a frame, on which a pusher is mounted which moves the single selected product outside the support shelf and from a tray which collects the selected product and positions it at an opening, which permits its withdrawal by the user.

Operatively, the frame is equipped with a vertical movement so to position both the pusher and the collection tray perfectly in line with the product selected by the user, while the pusher is equipped with a horizontal movement so to position itself in line with the row containing the aforesaid product.

Further characteristic of the finding consists of the fact that the stroke of the pusher, which operates on the rear part of the row of products contained in a cell, is not placed in relation with the thickness of the product to be unloaded, which therefore permits the possibility to position products of different thicknesses aligned in a row in the same cell, without having to make a complex functioning program.

This is made possible by positioning a position detector on the collection tray, which controls the falling step of the product from the shelf after the push of the pusher, and when the product is completely deposited on the collection tray it sends a signal which stops the stroke of the aforesaid pusher, so that the product immediately following the fallen product remains on the rack.

These and other characteristics of the finding are highlighted by means of the description of one of its possible embodiments, given only as a not limiting example, with the air of the attached drawing tables where:

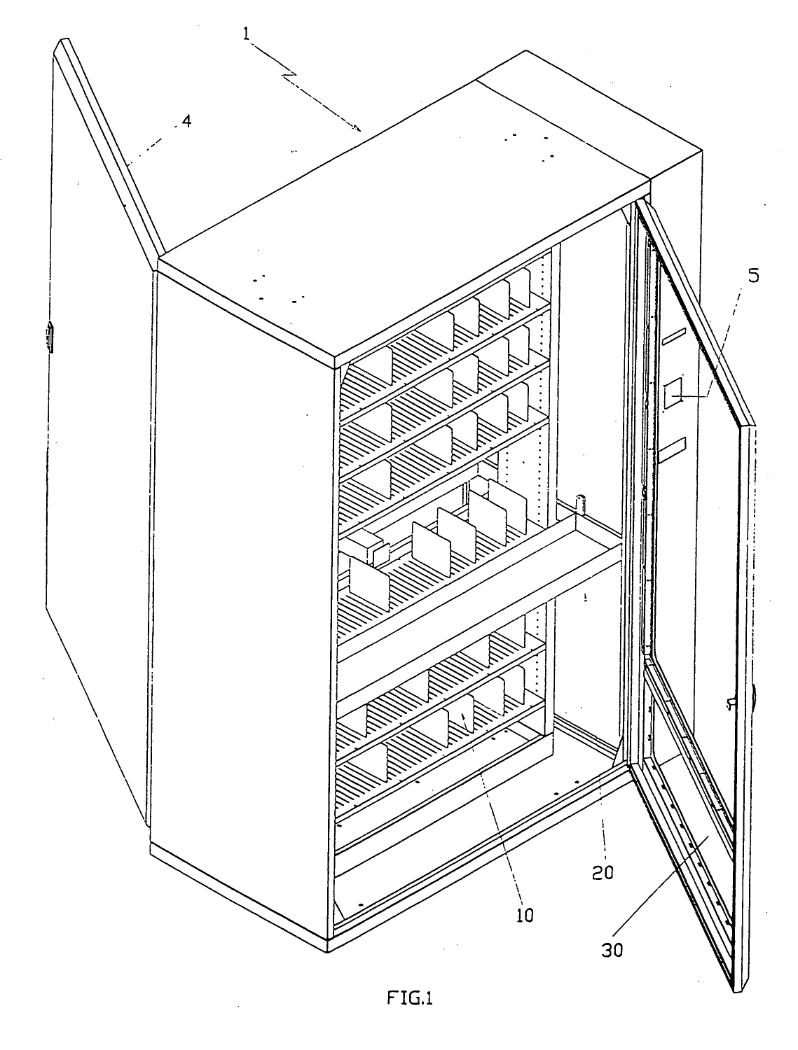

FIG. 1 (Table I) represents a perspective view of the vending machine according to the according to the finding;

FIG. 2 (Table II) represents an exploded view of the vending machine according to the finding;

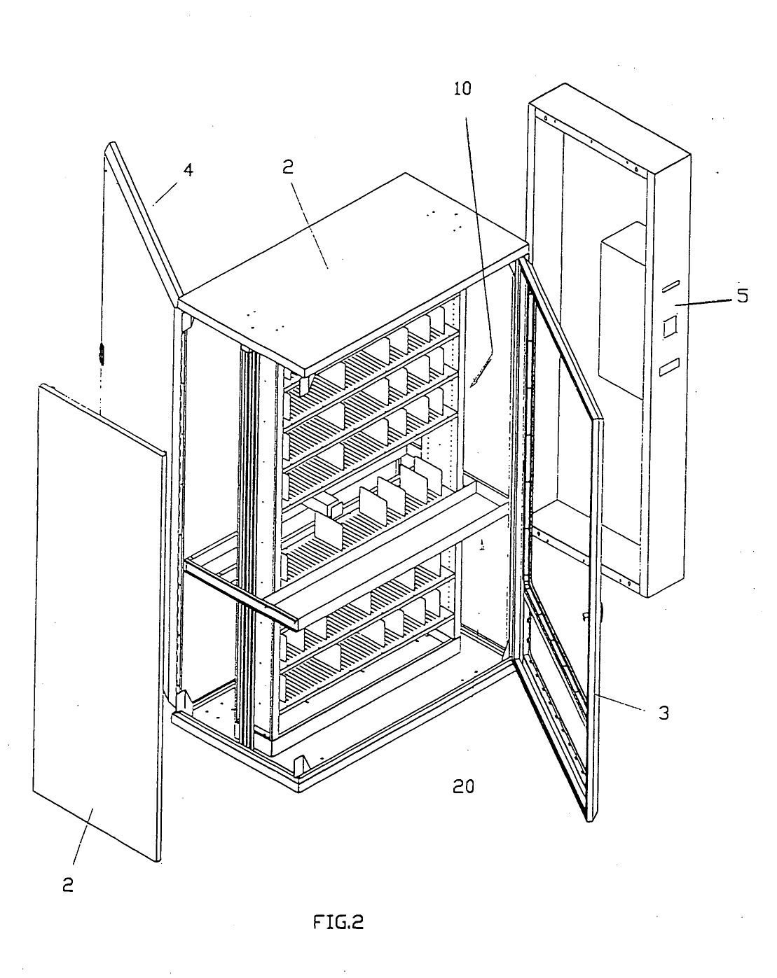

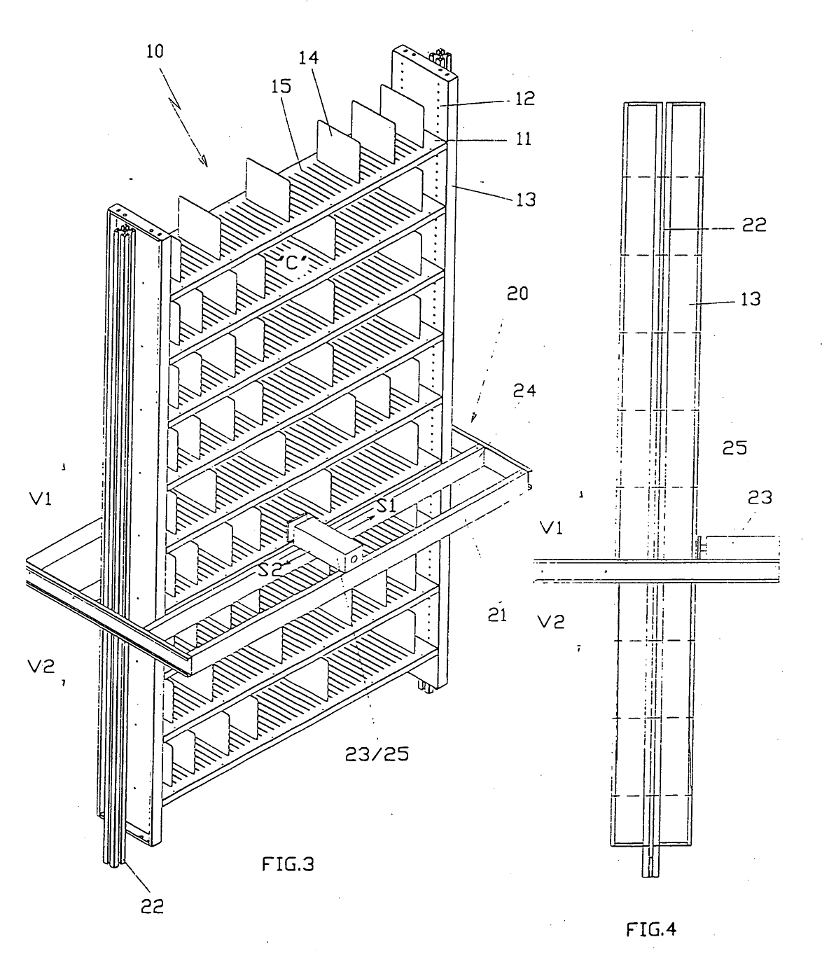

FIGS. 3 and 4 (Table III) respectively represent a rear perspective view and a lateral view of the storage area, in rest conditions;

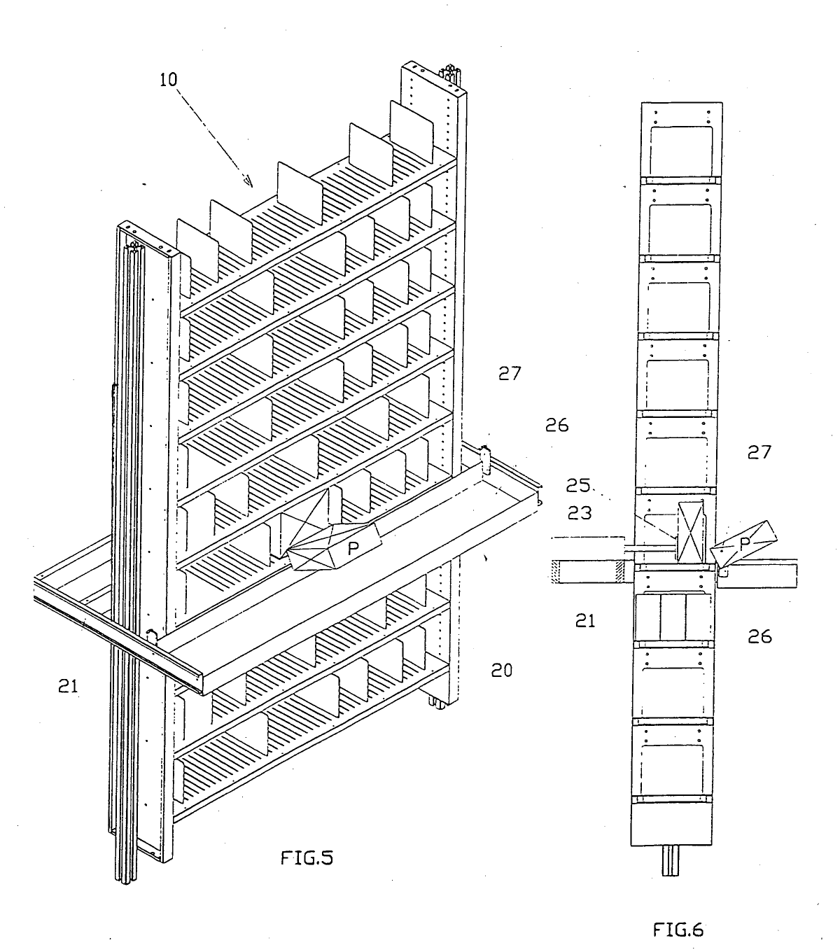

FIGS. 5 and 6 (Table IV) respectively represent a front perspective view and a lateral view of the storage area, in operating conditions;

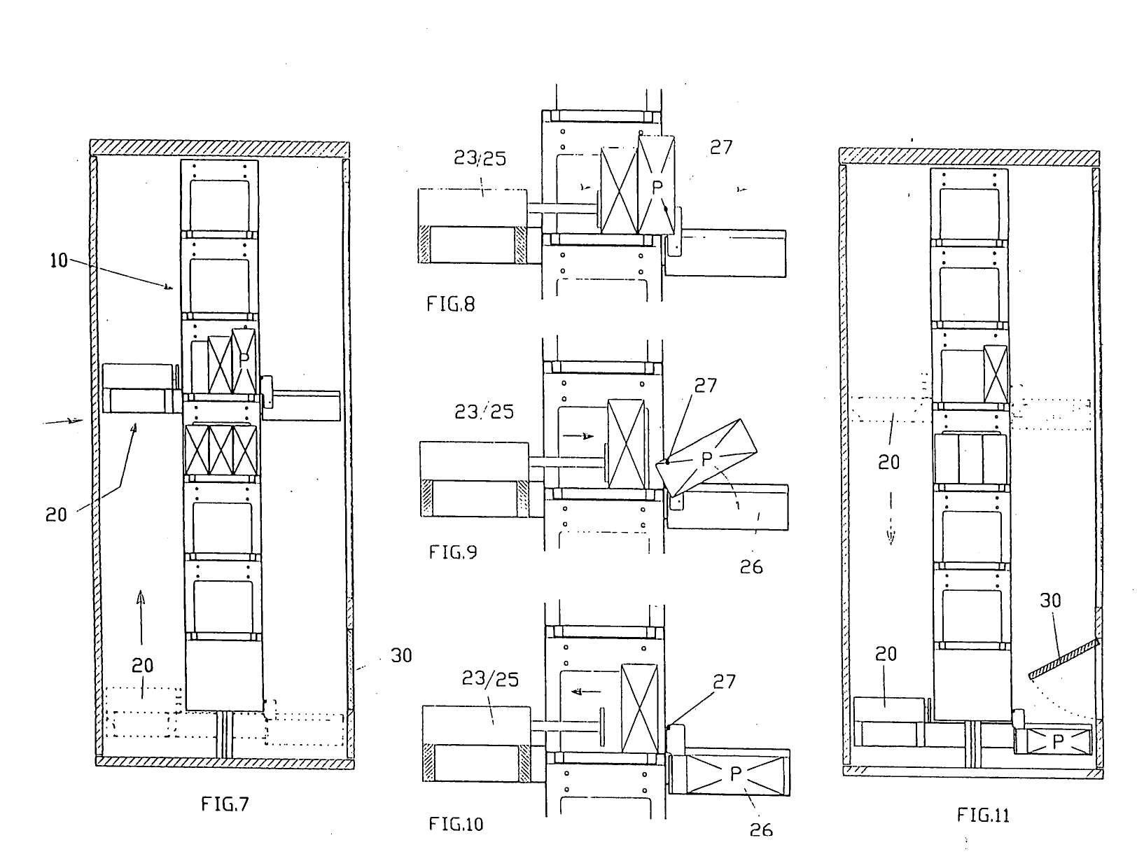

FIGS. 7-11 (Table V) represent the working steps of the vending machine according to the finding.

As is visible in FIGS. 1 and 2, an automatic vending machine, indicated in its entirety with the reference 1, comprises a cover 2 equipped with front 3 and rear 4 large doors, a push-button panel 5 and contains at its interior the storage area of the products, indicated in its entirety with the reference 10, and a device for moving (unloading) the single product, indicated in its entirety with the reference 20, all according to a in se known general configuration.

As is visible in FIGS. 3-6, the storage area of the products 10 is shaped like a rack, in which the movable shelves 11 can be manually positioned at different heights by means of holes 12 present on the lateral backs 13.

Analogously, movable walls 14 are present on each shelf which can be manually positioned at different distances by means of the slits 15 present on the shelf, so to define “C” cells of different width in relation to the size of the products to be inserted in the specific cell.

The device 20 for moving the product comprises a frame 21 placed outside the storage area 10 and susceptible to vertically slide (see arrows V1, V2) on the guides 22, which are attached to the backs 13.

As is visible in FIGS. 3, 4 in the rear part of the frame 21, a pusher 23 is attached, susceptible to horizontally sliding on the guides 24 (see arrows S1, S2) and equipped with a push plate 25 with horizontal axis.

As is visible in FIGS. 5, 6, in the front part of the frame 21, a tray 26 is present, fixed to said frame and laterally equipped with a detector apparatus 27, such as a photocell or a laser beam, which detects the presence/absence of the product “P” in the unloading step.

The functioning of the vending machine according to the finding is of the “X-Y coordinates” type, since the unloading operation of the product “P” selected by the user on the push-button panel 5 is realised by means of two orthogonal movements, specifically with a vertical movement by means of which the frame 21 is positioned and stopped in line with the shelf which contains the preselected product, and with a subsequent horizontal movement by means of which the pusher 23 is positioned at the row which contains the aforesaid product.

With such orthogonal movements, which are realised with motor members of known type at the state of the art (not claimable) and by means of an operation which defines the coordinates of the stop points of the pusher 23, it is therefore possible to operate on the rear part of the product row so that, with a pushing action, the product which is located in front is caused to fall from the shelf, and is collected by a tray.

As is visible in FIGS. 7-11, the functioning of the vending machine according to the finding foresees the following steps:
after the user has selected the product on the push-button panel, the frame 21, from the lower rest position, is raised to be brought in correspondence with the shelf 11 containing the product “P”, while the pusher 23, with a horizontal movement, is positioned at the row containing the aforesaid product (see FIG. 7);
after the orthogonal positioning, the pusher 23, by means of the release of the plate 25, pushes ahead the row of the products arranged on the shelf, and such movement engages the photocell 27, which detects the projection of the product “P” (see FIG. 8);
the rear pushing action continuing, the product “P”, by gravity, is overturned from the shelf, and falls into the collection tray (see FIG. 9);
when the product “P” is totally contained in the tray, the photocell 27, no longer detecting the product “P”, blocks the pushing action and the plate returns inside the pusher;
lastly, the frame 21 lowers, positioning the tray 26 at the small door 30 made on the large front door 3, permitting the user to withdraw the requested product (see FIG. 11).

As may be easily inferred from that illustrated, with the vending machine according to the finding it is possible to dispense products of the most varied shapes and sizes which can be inserted in the storage area, both in the front and the back of the same, in always different modes, whether on the different shelves or inside the single cell; this is permitted by the movability both of the shelves 11 and the small walls 14, and by the fact that the stroke of the plate 25 of the pusher 23 is not predetermined and is not directly dependent on the thickness of the products present in the row subjected to the push.

Such considerable versatility of use implies that, after having terminated the configuration of the cells, the operation with which the “self-learning of the pusher” is realised, i.e. the identification of the X-Y coordinates of the stop points of the pusher at each cell, must be executed with considerable precision so to ensure that the plate of the pusher can operate in an optimal manner on all products inserted in that cell.

Such operation can be carried out in a substantially manual or automatic manner.

In the operation of manual self-learning, made possible by the very simplified shape both of the storage area 10 and the product movement device 20, the operator grips the pusher 23 and positions it at each cell “C” in the manner that, at his discretion and for his experience, he deems optimal with respect to the products contained in that cell.

In practice, the operator vertically establishes height of the shelf and horizontally the centring or laterality of the push point of the plate in the area of the cell, and this is memorised in the controller.

Of course such operation is executed every time the size of the cells is modified, or when the type of the products present in a cell is varied.

On the other hand, in the operation of automatic self-learning, the position of the pusher in each cell is defined by equipping the pusher itself with a position detector of both the shelf and the two walls which define the cell, and then applying “default” information, which establishes as push point the barycentre or a predetermined misalignment value of the cell area, the pusher positions itself and then memorises such position in the controller.

Of course, embodiments even quite different from that described are possible, as a function of the sizes and components used for the construction of the vending machine or the types of products to be dispensed, without for this departing from the scope of the following claims.

1. VENDING MACHINE, of the type where the user can withdraw the selected product directly from the machine, to be used in all places, from those industrial to those civilian,
said vending machine characterized in that
the storage area of the products is composed of a rack and the dispensing device of the single product is composed of a frame, on which a pusher is mounted which makes the selected product fall into a tray, which positions the product at an opening which permits its withdrawal by the user.

2. VENDING MACHINE, according to claim 1, characterized in that in the rack both the shelves and the dividing walls, which define the containment cells of the products on each shelf, are movable and therefore susceptible to being positioned so to obtain any cell size.

3. VENDING MACHINE, according to claim 1, characterized in that the frame is equipped with a vertical movement, so to position both the pusher and the collection tray perfectly in line with the product selected by the user, while the pusher is equipped with a horizontal movement so to be positioned in line with the row containing the aforesaid product.

4. VENDING MACHINE, according to claim 1, characterized in that a position detector is attached in the collection tray which controls the falling step of the product from the shelf after the push of the pusher, and when the product is completely deposited on the collection tray, said detector sending a signal which stops the stroke of the aforesaid pusher, so that the product immediately following the fallen one remains on the rack.

5. VENDING MACHINE, according to claim 1, which comprises a cover (2), equipped with large front (3) and rear (4) doors, a push-button panel (5) and contains at its interior the storage area of the products (10) and a device (20) for moving or unloading the single product, said vending machine characterized in that the storage area of the products (10) is shaped as a rack, in which the movable shelves (11) can be manually positioned at different heights by means of the holes (12) present on the lateral backs (13), and the movable walls (14) on each shelf can be manually positioned at different distances by means of the slits (15) present on the shelf, so to define different size cells.

6. VENDING MACHINE, according to claim 5, characterized in that the device (20) for moving the product (P) comprises a frame (21) placed outside the storage area (10), and susceptible to vertically sliding on the guides (22) attached on the backs (13) of the fixed rack.

7. VENDING MACHINE, according to claim 6, characterised characterized in that a pusher (23) is attached in the rear part of the frame (21) which is susceptible to horizontally sliding on the guides (24) and is equipped with a push plate (25) with horizontal axis.

8. VENDING MACHINE, according to claim 7, characterized in that a tray (26) is present in the front part of the frame (21), fixed to said frame and laterally equipped with a detector apparatus (27), such as a photocell or a laser beam, which detects the presence/absence of the product (P) in the unloading step.

9. VENDING MACHINE, according to claim 8, characterized in that it operates with the following steps:
a) after the user has selected the product on the pushbutton panel, the frame (21), from the rest position, is raised to be brought in correspondence with the shelf (11) contained the selected product (P) while the pusher (23), with a horizontal movement, is positioned at the row containing the aforesaid product;
b) after the X-Y orthogonal positioning, the pusher (23), by means of the release of the plate (25), pushes ahead the row of the products arranged on the shelf, and such movement engages the photocell (27) which detects the projection of the product (P)
c) the rear pushing action continuing, the product (P), by gravity, is overturned from the shelf and falls into the collected tray (26);
d) when the product (P) is totally contained in the tray, the photocell (27), no longer detecting the product, blocks the pushing action and the plate (25) returns into the pusher (23);
e) the frame (21) lowers, positioning the tray at the small door (30) made on the large front door (3), permitting the user to withdraw the requested product.

10. VENDING MACHINE, according to claim 9, characterized in that the self-learning operation of the pusher (23), i.e. the identification of the X-Y coordinates of the stop point of the pusher at each cell, occurs manually with the operator who grips the apparatus and at every cell “C” positions it in the manner which he deems optimal with respect to the products contained in each cell, and memorises its position in the controller.

11. VENDING MACHINE, according to claim 9, characterized in that the self-learning operation of the pusher (23), i.e. the identification of the X-Y coordinates of the stop points of the pusher at each cell “C”, occurs automatically by equipping the pusher itself with a position detector of both the shelf and the two walls which define the cell, and then, applying “default” information which establishes as push point the barycentre or a predetermined misalignment value of the cell area itself, the pusher positions itself and then memorizes such position in the controller.

12. VENDING MACHINE, according to claim 7, characterized in that the stroke of the plate (25) of the pusher (23) is not predetermined and is not directly dependent on the thickness of the products present on the row and subjected to the push.
